(19) United States
(12) Patent Application Publication
(10) Pub. No.: US 2004/0147348 A1
(43) Pub. Date: Jul. 29, 2004

(54) Split sprocket drive mechanism for transmitting rotary motion of a shaft to an encoder

(76) Inventors: David Yiu, Tucson, AZ (US); Romer Johnson, Oro Valley, AZ (US)

Correspondence Address: QUARLES & BRADY STREICH LANG, LLP, ONE SOUTH CHURCH AVENUE, SUITE 1700, TUCSON, AZ, 85701-1621, US

(21) Appl. No.: 10/350,613

(22) Filed: Jan. 24, 2003

(51) Int. Cl. F16H 55/12

(52) U.S. Cl. 474/95; 474/96

(57) ABSTRACT

A drive system monitors the rotary motion of a shaft and transmits the rotary motion to an encoder. The drive system includes a drive sprocket that is coupled to the rotating shaft by a pair of disc-shaped hubs with the sprocket being sandwiched between the two hubs. The sprocket has an axial bore formed therethrough and is split into semi-circular halves to facilitate circumferential mounting of the sprocket on the shaft to be monitored. The two disc-shaped hubs which couple the sprocket to the shaft have axial bores formed therethrough and are split into two segments each of which is preferably less than semi-circular to allow the hubs to be clamped in circumferential engagement on shafts of various diameters within a predetermined range of diameters. A chain is connected to the drive sprocket for transmitting the monitored rotary motion of the shaft to the driven sprocket of the encoder.

### BACKGROUND OF THE INVENTION

1. Field of the Invention

This invention relates in general to drive systems and more particularly to a split sprocket drive mechanism for mounting on a shaft and transmitting rotary motion of the shaft to drive an encoder.

2. Description of the Invention

In many mechanized industrial systems the rotary motion of a shaft is monitored and coupled to an encoder to provide data for proper system operation and to keep the system's operators appraised of the status of the tasks being accomplished by the system.

By way of example, in mining operations the drilling of blast holes is accomplished by equipment that includes a drill shaft which carries a drill bit. The drill shaft and bit are driven into the ground formation by rotary motion supplied from a conventional power source to a drive shaft. The drive shaft couples the rotary motion to the drill shaft and bit through a suitable gear assembly. Rotation of the drive shaft is monitored to let the equipment's operators know the depth to which the drill shaft and bit have penetrated into the ground formation.

Some manufactures of prior art equipment used for monitoring the rotation of the drive shaft includes a geared sprocket that is built on the shaft and coupled by a chain to the driven sprocket of an encoder. Other prior art equipment includes a drive pulley that is mounted on the shaft and is coupled by means of a V-belt to a driven pulley provided on the encoder. In either case, the encoder responds to each revolution of the drive shaft by counting or otherwise producing a suitable data signal by which the penetration depth of the drill shaft can be determined.

In mining installations where the drive shaft is not manufactured with an integral drive sprocket, it is desirable to retrofit the installation to provide a means for coupling rotary motion of the drive shaft to the encoder and this is accomplished by mounting a split hub-pulley device on the shaft. Split pulleys are used rather than one piece devices due to the lack of axial accessability of the drive shafts. In addition to retrofitting such drive shafts, the use of split hub-pulley device allows the monitoring mechanism to be moved onto other drive shafts that are not manufactured with an integral sprocket.

The prior art monitoring mechanisms for retrofitting drive shafts are not always reliable in that they must be periodically adjusted to minimize belt slippage and since they operate in a hostile environment, belt slippage often occurs whenever dirt grease or other contaminants produce a reduction in the frictional engagement of the V-belt on the pulleys. Another problem with such prior art monitoring mechanisms is that the drive shafts of the several drilling equipment installations are not always of the same diameter. Typically, the tolerance of such shafts is plus or minus ¼ of an inch and it is difficult for a single split pulley to properly fit on shafts of such varying diameters. If the bore of the split pulley is smaller than the diameter of the drive shaft it simply will not fit on the shaft and if it is larger, tape or some other material must be used to fill the gap between the bore of the pulley and the periphery of shaft. In that retrofitting of drive shafts is done in the field, modification of the split pulley to make it fit is difficult and the outside diameter of such modified devices will vary thus requiring that each installation be individually calibrated.

Therefore, a need exists for a new and useful rotating shaft monitoring system which overcomes some of the problems and shortcomings of the prior art.

### SUMMARY OF THE INVENTION

In accordance with the present invention, a new and useful drive mechanism is disclosed for monitoring the rotary motion of a shaft and transmitting the rotary motion to an encoder. The drive mechanism includes a sprocket that is coupled to the rotating shaft by a pair of disc-shaped hubs with the sprocket being sandwiched between the two hubs. The sprocket has an axial bore formed therethrough and is split along a parting line into semi-circular halves to facilitate circumferential mounting of the sprocket on the shaft to be monitored and subsequently removed from the shaft when it is to be moved to a new location. The axial bore of the sprocket is formed with a diameter that is larger than the diameter of the shafts upon which it is to be mounted so that it can be used on all shafts having diameters within a predetermined range and to provide the sprocket with a fixed outside diameter and perfectly aligned sprocket teeth. The two disc-shaped hubs which couple the sprocket to the shaft to be monitored have axial bores formed therethrough which are sized between the maximum and minimum diameters of the predetermined range of shaft diameters to be monitored. Each of the hubs are split along a parting line for the same reasons that the sprocket is split. However, in the preferred embodiment, the hubs are split into two segments each of which is less than semi-circular. Therefore, when the two segments of each of the hubs are mounted on the shaft to be monitored and connected to each other by a clamping means, there will be a gap along the parting line between the two segments of each of the hubs. When the shaft has a large diameter, the two segments of each hub will be in a radially extended position and the gap therebetween will be large and similarly, when the diameter of the shaft is small, the two segments of each hub will be in a radially contracted position with the gap being correspondingly smaller.

The sprocket is held between the two hubs by a suitable joining means in the preferred form of fasteners which extend through the two hubs and through the sprocket to form them into a unitary assembly. The two halves of the split sprocket must be positioned in engagement with each other along the parting line so that the teeth of the sprocket will be in properly spaced alignment. Also, the sprocket needs to be adjusted radially between the two hubs so that it is concentric with the shaft with such adjustment compensating for the radially extended or contracted positions of the segments of the two hubs. Such adjustment can be made by loosening the joining means which hold the two hubs and the sprocket together.

When the drive mechanism described above is mounted on a shaft to be monitored, the sprocket drives a suitable chain which transmits the rotary motion of the shaft to a driven sprocket of an encoder that is mounted in spaced parallel relationship with respect to the shaft.

Accordingly, it is an object of the present invention to provide a new and useful drive mechanism for monitoring the rotary motion of a shaft and transmitting the rotary motion to an encoder.

Another object of the present invention is to provide a drive mechanism of the above describe type which is mountable on any shaft having a diameter within a predetermined range of diameters.

Another object of the present invention is to provide a drive mechanism of the above described character that includes a split sprocket which is mounted between a split pair of hubs to allow the mechanism to be circumscribingly positioned on the shaft and clamped into gripping engagement with the shaft.

Another object of the present invention is to provide a drive mechanism of the above described type wherein the split sprocket has an axial bore the diameter of which is larger that the largest diameter of the shafts within the predetermined range of diameters upon which it is to be mounted so that the outside diameter and sprocket teeth alignment of the sprocket will be unaffected by the shaft diameter.

Still another object of the present invention is to provide a drive mechanism of type the above described wherein the pair of hubs are split into two segments of less than semi-circular configuration to allow them to be circumferentially mounted on shafts having different diameters within a predetermined range of diameters.

Yet another object of the present invention is to provide a drive mechanism of the above described character which does not require any modifications in the field to make it fit on shafts of various diameters within a predetermined range of diameters.

The foregoing and other objects of the present invention as well as the invention itself will be more fully understood from the following description when read in conjunction with the accompanying drawings.

### BRIEF DESCRIPTION OF THE DRAWINGS

FIG. 1 is a perspective view showing the drive mechanism of the present invention as being mounted on a shaft for transmitting the rotary motion of the shaft to an encoder.

FIG. 2 is an exploded perspective view of the drive mechanism of the present invention.

FIG. 3 is a sectional view taken along the line 3-3 of FIG. 1 and showing the drive mechanism mounted on a small diameter shaft.

FIG. 4 is a view similar to FIG. 3 and showing the drive mechanism mounted on a large diameter shaft.

FIG. 5 is a view similar to FIG. 3 and showing the drive mechanism mounted on a median diameter shaft with portions of the drive mechanism being broken away to show the various features thereof.

FIG. 6 is a side elevational view of the drive mechanism of the present invention.

### DESCRIPTION OF THE PREFERRED EMBODIMENTS

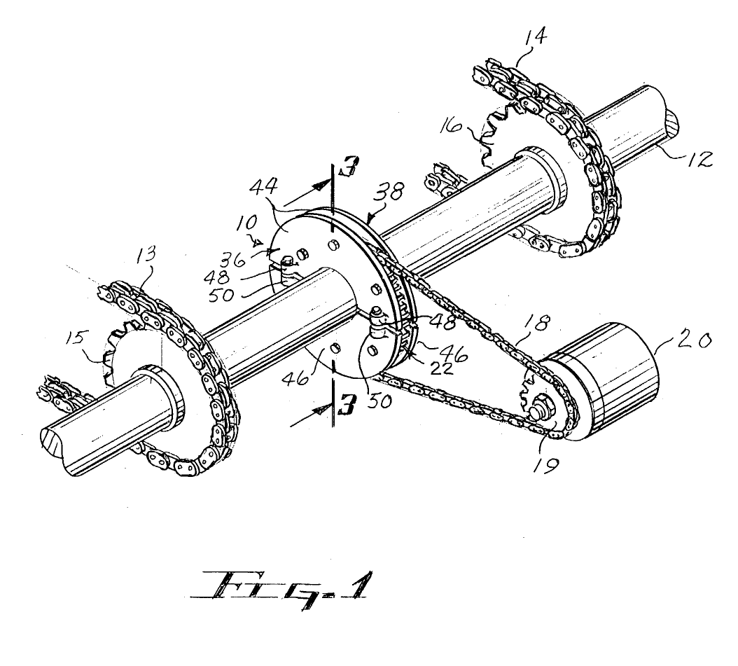

Referring more particularly to the drawings, FIG. 1 shows the drive mechanism of the present invention which is indicated generally by the reference numeral 10, with the drive mechanism being mounted on a shaft 12. The shaft 12 is rotatably driven in a suitable manner such as by the illustrated chains 13 and 14 which drive an axially spaced pair of sprockets 15 and 16 respectively, with the sprockets being fixedly mounted on the shaft 12. Alternatively, the shaft 12 may be driven by a suitable gear drive assembly (not shown), and in either case, the drive mechanism 10 is rotatable with the shaft 12 for monitoring the rotary motion of the shaft. The drive mechanism 10 is coupled by a chain 18 to the driven sprocket 19 of an encoder 20, as will hereinafter be described in detail.

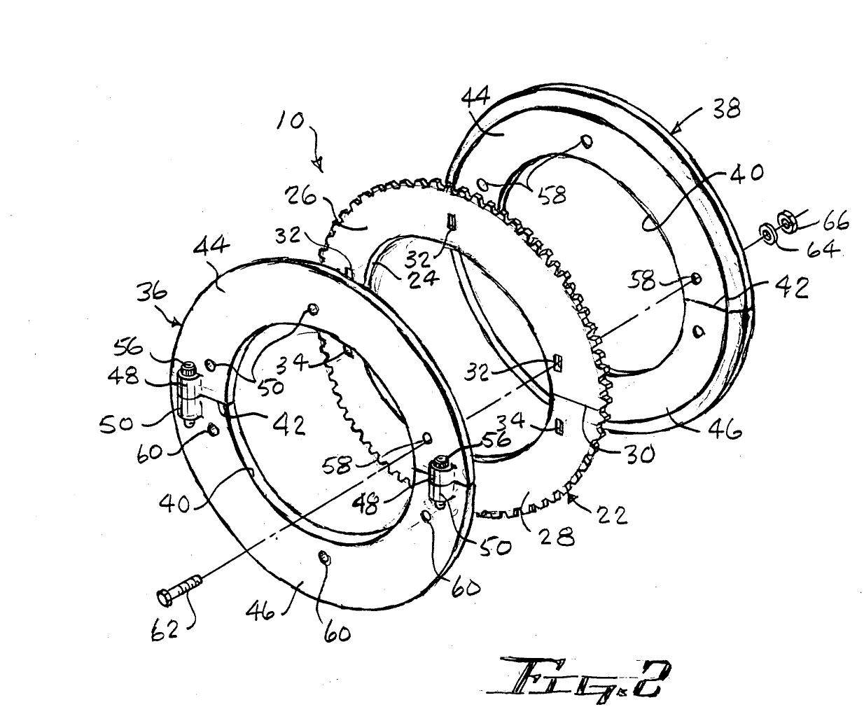

As best seen in FIG. 2, the drive mechanism 10 is seen to include a sprocket 22 which defines an axial bore 24, and the sprocket is split into two semi-circular halves 26 and 28 along a parting line 30 to allow circumferential positioning on the shaft 12. When mounted on the shaft 12, the semi-circular sprocket halves 26 and 28 must be in contact with each other along their parting line 30 to provide proper spacing and alignment of the sprocket teeth. Three radially spaced apertures 32 are formed through the sprocket half 26 and three (two shown) apertures 34 are similarly formed through the other sprocket half 28. The drive mechanism 10 also includes an identical pair of disc-shaped hubs 36 and 38. Since the hubs 36 and 38 are identical, the following detailed description of the hub 36 will be understood to also apply to hub 38.

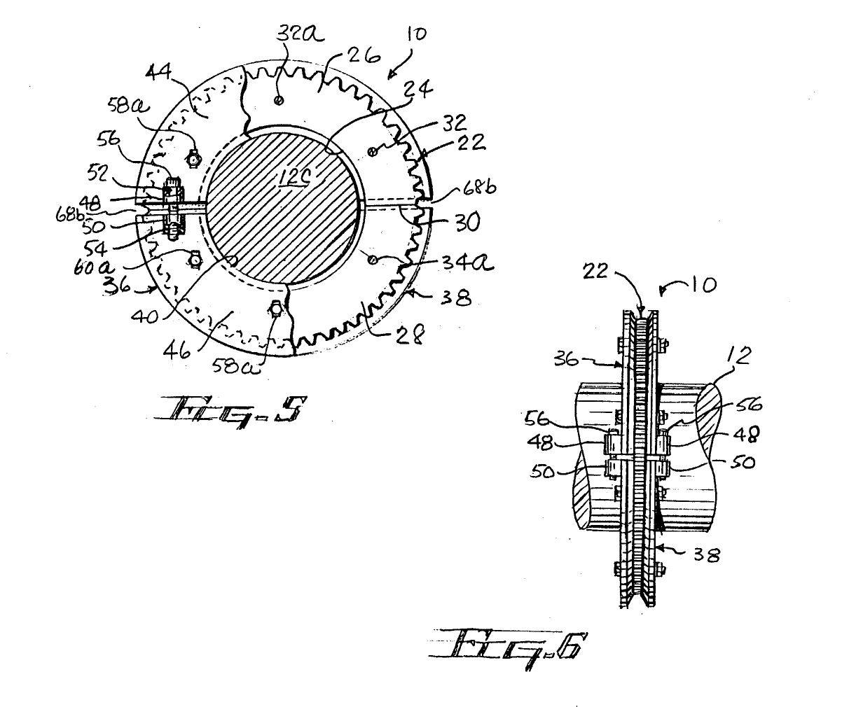

The hub 36 is fabricated to define an axial bore 40 and is split along a parting line 42. In the preferred embodiment, the hub is split into two segments 44 and 46 each of which is preferably smaller than a semi-circle for reasons which will hereinafter be described in detail. The hub segment 44 is formed with a pair of bosses 48 each of which is disposed adjacent a different opposite side of the segment along the parting line 42, and the other segment 46 is similarly formed with a pair of bosses 50. The bosses 48 each have an axial bore 52 formed therethrough as seen in FIG. 5 and the bosses 50 have threaded bores 54 formed therethrough. When the two segments 44 and 46 are positioned as shown in FIG. 2, the bosses 48 and 50 thereof are aligned with each other and suitable bolts 56 are used to interconnect them and thus provide a clamping means by which the segments are assembled into the disc-shaped hub configuration about the periphery of the shaft 12. Three radially spaced apertures 58 are formed through the segment 44 and three apertures 60 are similarly formed through the other segment 46.

Assembly of the sprocket 22 and the two hubs 36 and 38 in a clamped circumscribing position on the shaft 12 will now be described. The sprocket half 26 is positioned between the hub segments 44 of the hubs 36 and 38 and a joining means in the form of suitable bolts 62 are passed through the aligned apertures 58 thereof and the apertures 32 of the sprocket 22 and washers 64 and nuts 66 are threaded onto the bolts 62. The other sprocket half 28 is similarly positioned between the two hub segments 46 of the hubs 36 and 38 and are connected to each other by the joining means describe above. The assembled sprocket half 26 and hub segments 44 and the assembled other sprocket half 28 and hub segments 46 are placed on diametrically opposed sides of the shaft 12. The hub segments 44 and 46 of each of the hubs 36 and 38 are then interconnected by the bolts 56 as described above to assemble them into the disc-shaped hub structures and clamp them in place about the shaft 12.

The drive mechanism 10 is designed for retrofitting shafts which are not manufactured with integral drive mechanisms and to be movable from one location to another to monitor the rotation of shafts at those locations, and such shafts different are not always of the same diameter. For this reason, the sprocket 22 and the hubs 36 and 38 are especially configured so that the drive mechanism 10 can be mounted on shafts having various diameters within a predetermined range of diameters. The axial bore 24 of the sprocket 22 is formed with a diameter that is larger than the largest diameter of the shafts upon which it is to be mounted and the two disc-shaped hubs 36 and 38 have their axial bores 40 preferably sized between the maximum and minimum diameters of the predetermined range of shaft diameters to be monitored.

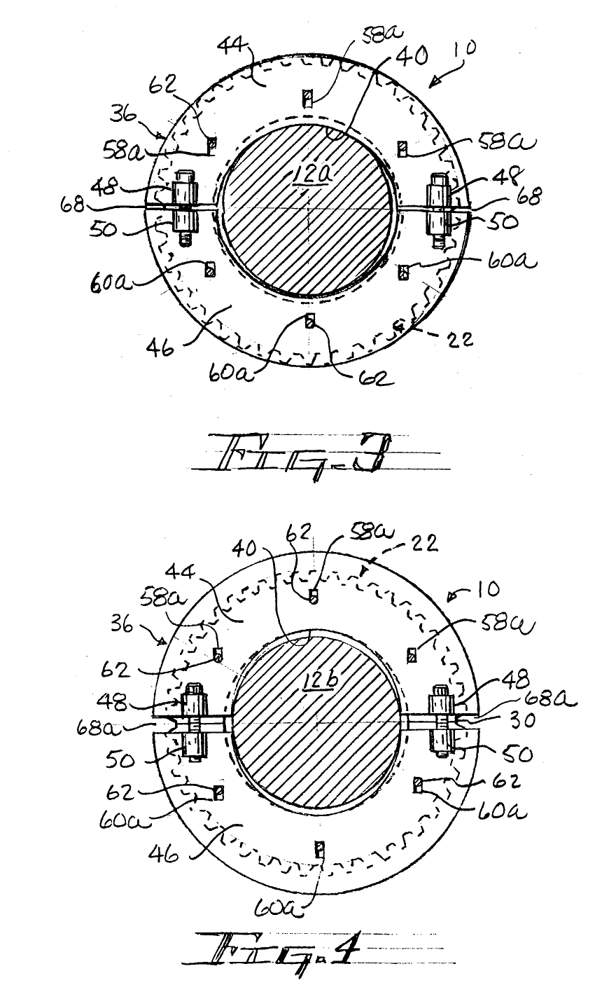

As previously mentioned, each of the segments 44 and 46 of the hubs 36 and 38 are preferably formed to be of less than semi-circular configuration, so that when they are mounted on a relatively small diameter shaft 12a as seen in FIG. 3, the two hubs will be in a radially contracted position and there will be a relatively small gap 68 along the parting line 42 between the two segments of each of the hubs. When the hubs 36 and 38 are mounted on a relatively large diameter shaft 12b as seen in FIG. 4, the two hubs will be in a radially extended position and the gap 68a will be comparatively large. Similarly, FIG. 5 shows the drive mechanism 10 as being mounted on a shaft 12c of mean diameter wherein the hub segments 44 and 46 are in an intermediate position, that is, they are neither expanded nor contracted and the size of the gap 68b will be between the above described small and large gaps 68 and 68a respectively.

It has been determined that for example, when the shaft 12 has a diameter of nine inches, and a manufacturing tolerance of plus or minus one half of an inch, forming each of the hub segments 44 and 46 with one forth of an inch removed from each of the hub segments along their part lines will reduce them from a semi-circular configuration into properly sized segments of less than semi-circular configuration so that they can be assembled as described above onto such a shaft.

The previously mentioned aligned apertures 58 and 60 of the hubs 36 and 38 and the apertures 32 and 34 of the sprocket 22 are of special configuration to allow the sprockets halves 26 and 28 to remain in contact with each other along their parting line 30 and to be concentrically positioned about the shaft 12 regardless of the radially contracted or extended positioning of the segments 44 and 46 of the hubs.

In a first embodiment, the special aperture configuration is shown in FIG. 2 as having the apertures 58 and 60 formed of circular configuration through the hubs 36 and 38 and slot shaped apertures 32 and 34 formed in the sprocket 22. A second embodiment of the special aperture configuration is shown in FIG. 5. The apertures 32a and 34a formed in the sprocket halves 26 and 28 are circular and the apertures 58a and 60a formed in the hub segments 44 and 46 are of slotted configuration. Regardless of which configuration of the special apertures is provided in the drive mechanism 10, when the bolts 62 are loose, the hub segments 44 and 46 can be radially contracted or extended as needed to fit the shaft and the sprocket 22 can be adjustably moved toward or away from the shaft to compensate for the radial positioning of the hub segments.

As seen best in FIG. 6, the hubs 36 and 38 have a greater diameter than the sprocket 22 so that the chain 18 which transmits rotary motion of the shaft 12 to the driven sprocket 19 of the encoder 20 will be held in engagement with the teeth of the sprocket 22 and thereby eliminate or at least minimize derailing.

The encoder 20 may be any suitable device which responds to each revolution of the shaft 12 by counting or otherwise producing a suitable data signal which is indicative of the monitored rotation of the shaft. A suitable commercially available encoder is identified as model No.200564 and is available from Modular Mining Systems, Inc., whose address is 3289 E. Hemisphere Loop, Tucson Ariz. 85706.

While the principles of the invention have now been made clear in illustrated embodiments, many modifications will be obvious to those skilled in the art which do not depart from those principles. The appended claims are therefore intended to cover such modifications within the limits only of the true spirit and scope of the invention.

What we claim is:

1. A drive mechanism for demountable mounting on rotatable shafts, said drive mechanism comprising:
a) a sprocket having an axial bore and split along a parting line into two parts for circumferential placement about one of the rotatable shafts;
b) a pair of disc-shaped hubs each defining an axial bore and each being split along a parting line into two parts for circumferential placement about the one of the rotatable shafts on opposite sides of said sprocket,
c) clamping means on each of said pair of hubs for demountable interconnection of the two parts thereof in circumferential clamping engagement on the one of the rotatable shafts; and
d) joining means for demountably interconnecting said pair of hubs and said sprocket into a unitary structure.

2. A drive mechanism as claimed in claim 1 wherein each of the two parts of said pair of hubs is a segments of less than semi-circular configuration to allow circumferential placement about various diameters of the rotatable shafts.

3. A drive mechanism as claimed in claim 2 wherein the axial bore formed through said sprocket is as large or larger than the largest diameter of the rotatable shafts upon which it is mountable.

4. A drive mechanism as claimed in claim 1 wherein said clamping means on each of said pair of hubs comprises:
a) a first pair of bosses each formed adjacent an opposite side edge of one of the two parts of said hub along the parting line thereof, each of said first pair of bosses having a bore formed therethrough;
b) a second pair of bosses formed on a second one of the two parts of said hub and being disposed to align with said first pair of bosses when the two parts of said hub are in circumferential placement about one of the rotatable shafts, each of said second pair of bosses having a threaded bore formed therein; and
c) a pair of bolts each passing through the bore of a different one of said first pair of bosses into threaded engagement with a different one of the threaded bores of said second pair of bosses.

5. A drive mechanism as claimed in claim 2 wherein said joining means comprises:
a) said sprocket having a plurality of apertures formed therethrough;
b) each of said pair of hubs having a plurality of apertures formed therethrough each of which aligns with a different one of the plurality of apertures formed through said sprocket; and
c) a threaded fastener passing through each of the aligned apertures formed in said sprocket and in said pair of hubs for joining thereof into a unitary structure.

6. A drive mechanism as claimed in claim 5 wherein the plurality of apertures formed through said sprocket are of slotted configuration to allow said sprocket to be radially adjusted relative to the one of the shafts when said sprocket and said pair of hubs are mounted thereon and said threaded fasteners are loosened.

7. A drive mechanism as claimed in claim 5 wherein the plurality of apertures formed in each of said hubs are of slotted configuration to allow said sprocket to be radially adjusted relative to the one of the shafts when said sprocket and said pair of hubs are mounted thereon and said threaded fasteners are loosened.

8. A drive mechanism for demountable mounting on rotatable shafts the diameters of which can vary from shaft to shaft within a predetermined range of diameters, said drive system comprising:
a) a sprocket having an axial bore and split into two semi-circular halves for circumferential placement about one of the rotatable shafts;
b) a pair of disc-shaped hubs each defining an axial bore and each being split along a parting line into two segments for circumferential placement about the one of the rotatable shafts on opposite sides of said sprocket, each of the segments of said pair of hubs being of less than semi-circular configuration to allow circumferential placement about the shafts of various diameters;
c) clamping means on each of said pair of hubs for demountable interconnection of the two segments thereof in circumferential clamping engagement on the one of the rotatable shafts; and
d) joining means for demountably interconnecting said pair of hubs and said sprocket into a unitary structure.

9. A drive mechanism as claimed in claim 8 wherein the axial bore formed through said sprocket is larger than the largest diameter of the rotatable shafts upon which it is mountable.

10. A drive mechanism as claimed in claim 8 wherein said clamping means on each of said pair of hubs comprises:
a) a first pair of bosses each formed adjacent an opposite side edge of one of the two segments of said hub along the parting line thereof, each of said first pair of bosses having a bore formed therethrough;
b) a second pair of bosses formed on a second one of the two segments of said hub and being disposed to align with said first pair of bosses when the two segments of said hub are in circumferential placement about the one of the rotatable shafts, each of said second pair of bosses having a threaded bore formed therein; and
c) a pair of bolts each passing through the bore of a different one of said first pair of bosses into threaded engagement with a different one of the threaded bores of said second pair of bosses.

11. A drive mechanism as claimed in claim 8 wherein said joining means comprises:
a) said sprocket having a plurality of apertures formed therethrough;
b) each of said pair of hubs having a plurality of apertures formed therethrough each of which aligns with a different one of the plurality of apertures formed through said sprocket; and
c) a threaded fastener passing through each of the aligned apertures formed in said sprocket and in said pair of hubs for joining thereof into a unitary structure.

12. A drive mechanism as claimed in claim 11 wherein the plurality of apertures formed through said sprocket are of slotted configuration to allow said sprocket to be radially adjusted relative to the one of the shafts when said sprocket and said pair of hubs are mounted thereon and said threaded fasteners are loosened.

13. A drive mechanism as claimed in claim 11 wherein the plurality of apertures formed in each of said hubs are of slotted configuration to allow said sprocket to be radially adjusted relative to the one of the shafts when said sprocket and said pair of hubs are mounted thereon and said threaded fasteners are loosened.

14. A drive system for monitoring the rotary motion of rotatable shafts and transmitting the rotary motion to an encoder, said drive system comprising:
a) a pair of disc-shaped hubs each having an axial bore and each being split along a parting line into two parts for circumferential placement about one of the shafts; b) a drive sprocket having an axial bore and split into two parts for circumferential placement about the one of the rotatable shafts intermediate said pair of hubs;
c) clamping means on each of said pair of hubs for demountable interconnection of the two parts thereof in circumferential clamping engagement on the one of the rotatable shafts;
d) joining means for demountably interconnecting said pair of hubs and said sprocket into a unitary structure;
e) an encoder having a driven sprocket; and
f) a chain connected between said drive sprocket and the driven sprocket of said encoder for transmitting the rotary motion of the one of the rotatable shafts to said encoder.

15. A drive system as claimed in claim 14 wherein each of the two parts of said pair of hubs is a segments of less than semi-circular configuration to allow circumferential placement thereof about shafts of various diameters within a predetermined range of diameters;

16. A drive system as claimed in claim 15 wherein said sprocket is split into semi-circular halves and the axial bore formed through said sprocket is larger than the largest diameter of the various shafts upon which it is mountable.

17. A drive system as claimed in claim 15 wherein said clamping means on each of said pair of hubs comprises:
a) a first pair of bosses each formed adjacent an opposite side edge of one of the two segments of said hub along the parting line thereof, each of said first pair of bosses having a bore formed therethrough;
b) a second pair of bosses formed on a second one of the two segments of said hub and being disposed to align with said first pair of bosses when the two segments of said hub are in circumferential placement about the one of the shafts, each of said second pair of bosses having a threaded bore formed therein; and
c) a pair of bolts each passing through the bore of a different one of said first pair of bosses into threaded engagement with a different one of the threaded bores of said second pair of bosses.

18. A drive mechanism as claimed in claim 15 wherein said joining means comprises:
a) said sprocket having a plurality of apertures formed therethrough;
b) each of said pair of hubs having a plurality of apertures formed therethrough each of which aligns with a different one of the plurality of apertures formed through said sprocket; and
c) a threaded fastener passing through each of the aligned apertures formed in said sprocket and in said pair of hubs for joining thereof into a unitary structure.

19. A drive system as claimed in claim 18 wherein the plurality of apertures formed through said sprocket are of slotted configuration to allow said sprocket to be radially adjusted relative to the one of the shafts when said sprocket and said pair of hubs are mounted thereon and said threaded fasteners are loosened.

20. A drive system as claimed in claim 18 wherein the plurality of apertures formed in each of said hubs are of slotted configuration to allow said sprocket to be radially adjusted relative to the one of the shafts when said sprocket and said pair of hubs are mounted thereon and said threaded fasteners are loosened.
